(19) United States
(12) Patent Application Publication
(10) Pub. No.: US 2013/0219949 A1
(43) Pub. Date: Aug. 29, 2013

(54) WORKING MEDIUM FOR ABSORPTION HEAT PUMPS

(71) Applicants: Matthias Seiler, Griesheim (DE); Rolf Schneider, Grundau-Rothenbergen (DE); Olivier Zehnacker, Dortmund (DE); Marc-Christoph Schneider, Darmstadt (DE)

(72) Inventors: Matthias Seiler, Griesheim (DE); Rolf Schneider, Grundau-Rothenbergen (DE); Olivier Zehnacker, Dortmund (DE); Marc-Christoph Schneider, Darmstadt (DE)

(73) Assignee: Evonik Degussa GmbH, Essen (DE)

(21) Appl. No.: 13/883,573

(22) PCT Filed: Nov. 4, 2011
(86) PCT No.: PCT/EP2011/069402

§ 371 Date: May 5, 2013

(30) Foreign Application Priority Data
Nov. 8, 2010 (EP) 101903565

(51) Int. Cl. C09K 5/04; F25B 15/00

(52) U.S. Cl. CPC C09K 5/047; F25B 15/00
USPC 62/476; 252/67

(57) ABSTRACT

A working medium comprising at least one refrigerant, at least one monohydric aliphatic alcohol having from 6 to 10 carbon atoms and at least one ionic liquid composed of at least one organic cation and at least one anion shows an improved efficiency COP in an absorption heat pump compared to working media which do not contain an alcohol having from 6 to 10 carbon atoms.

The invention relates to a working medium for absorption heat pumps, which comprises a refrigerant, an ionic liquid as sorption medium and an additive for improving mass transfer and heat transfer.

Classical heat pumps are based on a circuit of a refrigerant via an evaporator and a condenser. In the evaporator, a refrigerant is vaporized and the heat of vaporization taken up by the refrigerant is withdrawn from a first medium. The vaporized refrigerant is then brought to a higher pressure by means of a compressor and condensed in the condenser at a temperature higher than that in the vaporization, with the heat of vaporization being liberated again and heat being transferred to a second medium at a higher temperature level. The liquefied refrigerant is subsequently depressurized again to the pressure of the evaporator.

Classical heat pumps have the disadvantage that they consume a great deal of mechanical energy for compression of the gaseous refrigerant. Absorption heat pumps, in contrast, have a reduced mechanical energy consumption. Absorption heat pumps have a sorption medium, an absorber and a desorber in addition to the refrigerant, the evaporator and the condenser of a classical heat pump. The vaporized refrigerant is absorbed in the sorption medium in the absorber at the pressure of the evaporation and is subsequently desorbed again from the sorption medium in the desorber by supply of heat at a pressure higher than that of the condensation. Compression of the liquid working medium composed of refrigerant and sorption medium requires less mechanical energy than compression of the refrigerant vapour in a classical heat pump; the heat energy used for desorption of the refrigerant takes the place of the consumption of mechanical energy. The efficiency of an absorption heat pump is calculated as the ratio of the heat flow utilized for cooling or heating to the heat flow supplied to the desorber for operation of the absorption heat pump and is referred to as “coefficient of performance”, abbreviated to COP.

A large part of the absorption heat pumps used in industry use a working medium containing water as refrigerant and lithium bromide as sorption medium. In the case of this working medium, the mass transfer and heat transfer in the absorber can be improved by addition of small amounts of a

C6-12 alcohol and a higher efficiency COP can be achieved in this way, as is known, for example, from U.S. Pat. No. 3,276,217, U.S. Pat. No. 3,580,759 and U.S. Pat. No. 3,609,087. In industry, 2-ethyl-1-hexanol is predominantly added in amounts of about 100 ppm for this purpose. The effect of 2-ethyl-1-hexanol in the absorber is based on adsorption of the alcohol from the vapour phase on the liquid surface which leads to a local reduction in the surface tension and thus triggers Marangoni convection which leads to improved mass transfer and heat transfer, as is known from X. Zhou, K. E. Herold, Proc. of the Int. Sorption Heat Pump Conf. 2002 (ISHPC '02), pages 341-346. 2-Ethyl-1-hexanol has a surfactant action and reduces the surface tension of water from 76 mN/m at 20° C. to about 50 mN/m. Compared to water, the mixture of water and lithium bromide used in absorption heat pumps has an increased surface tension of 96 mN/m at 57% by weight of LiBr, and this can be reduced to values of about 40 mN/m by the addition of 2-ethyl-1-hexanol.

Working media containing water as refrigerant and lithium bromide as sorption medium have the disadvantage that the water concentration in the working medium must not go below 35-40% by weight since otherwise crystallization of lithium bromide and as a result problems up to solidification of the working medium can occur. With absorption refrigeration machines which use a working medium having water as refrigerant and lithium bromide as sorption medium, the heat therefore has to be removed in the absorber at a temperature level which in hot countries requires cooling via a wet cooling tower.

WO 2005/113702 and WO 2006/134015 propose the use of working media containing an ionic liquid having organic cations as sorption medium in order to avoid problems caused by crystallization of the sorption medium.

WO 2009/097930 describes the addition of surfactant additives to working media containing an ionic liquid having organic cations as sorption medium so as to improve the wetting of surfaces by the working medium. EP 2 093 278 Al discloses fatty alcohols such as isostearyl alcohol and oleyl alcohol as wetting-promoting additives for ionic liquids.

However, the prior art does not contain any teachings regarding additives which in the case of working media containing an ionic liquid having organic cations as sorption medium can improve mass transfer or heat transfer in the absorption of an absorption heat pump.

Ionic liquids display completely different behaviour in a mixture with the refrigerant water than does the sorption medium lithium bromide since they do not, in contrast to LiBr, increase the surface tension compared to water but reduce it significantly, as is known, for example, from W. Liu et al, J. Mol. Liquids 140 (2008) 68-72. The ionic liquid displays a surfactant behaviour similar to 2-ethyl-1-hexanol and accumulates at the liquid surface in a mixture with water. A person skilled in the art therefore had to proceed on the assumption that addition of 2-ethyl-1-hexanol to a mixture of ionic liquid and water would not lead to a large reduction in the surface tension in the same way as for a mixture of lithium bromide and water, and the improvement in the mass transfer and heat transfer observed in the case of mixtures of lithium bromide and water would not occur when 2-ethyl-1-hexanol is added to a mixture of ionic liquid and water.

The inventors of the present invention have now surprisingly found that, contrary to this expectation, the addition of even small amounts of a monohydric aliphatic alcohol having from 6 to 10 carbon atoms, like 2-ethyl-1-hexanol, to a working medium containing water as refrigerant and an ionic liquid as sorption medium in an absorption heat pump leads to a significant improvement in mass transfer and heat transfer in the absorption and a higher efficiency COP. It is likewise surprising that an improvement in the mass transfer and heat transfer in the absorption and a higher efficiency COP can be achieved by addition of such an alcohol even when methanol or ethanol is used as refrigerant.

The invention accordingly provides a working medium for absorption heat pumps which comprises at least one refrigerant, at least one monohydric aliphatic alcohol having from 6 to 10 carbon atoms and at least one ionic liquid composed of at least one organic cation and at least one anion.

The invention additionally provides an absorption heat pump which comprises an absorber, a desorber, a condenser, an evaporator and a working medium according to the invention.

For the purposes of the invention, the term absorption heat pump encompasses all apparatuses by means of which heat is taken up at a low temperature level and is released again at a higher temperature level and which are driven by supply of heat to the desorber. The absorption heat pumps of the invention thus encompass both absorption refrigeration machines and absorption heat pumps in the narrower sense in which absorber and evaporator are operated at a lower working pressure than the desorber and condenser and also absorption heat transformers in which absorber and evaporator are operated at a higher working pressure than the desorber and condenser. In absorption refrigeration machines, the uptake of heat of evaporation in the evaporator is utilized for cooling a medium. In absorption heat pumps in the narrower sense, the heat liberated in the condenser and/or absorber is utilized for heating a medium. In absorption heat transformers, the heat of absorption liberated in the absorber is utilized for heating a medium, with the heat of absorption being obtained at a higher temperature level than in the supply of heat to the desorber.

The working medium of the invention comprises at least one refrigerant, at least one monohydric aliphatic alcohol having from 6 to 10 carbon atoms and at least one ionic liquid composed of at least one organic cation and at least one anion. The working medium preferably comprises from 4 to 67% by weight of refrigerant, from 0.0001 to 10% by weight of alcohol having from 6 to 10 carbon atoms and from 30 to 95% by weight of ionic liquid.

The working medium of the invention comprises at least one refrigerant which is volatile, so that part of the refrigerant can be vaporized in the desorber by supply of heat from the working medium when the working medium is used in an adsorption heat pump. As refrigerant, the working medium of the invention preferably contains water, methanol, ethanol or mixtures of these refrigerants. The refrigerant is particularly preferably methanol, ethanol, a mixture of methanol and ethanol, a mixture of ethanol with water or a mixture of methanol with water. The refrigerant is most preferably ethanol. Working media according to the invention which contain methanol, ethanol or mixtures of methanol or ethanol with water as refrigerant can be used in absorption refrigeration machines for cooling to temperatures of less than 0° C. Working media according to the invention which contain water as refrigerant do not form any flammable vapours when the working medium is used in an absorption heat pump.

The working medium of the invention additionally comprises at least one monohydric aliphatic alcohol having from 6 to 10 carbon atoms which improves mass transfer and heat transfer in the absorption of refrigerant in the absorber when the working medium is used in an absorption heat pump. The alcohol is preferably a primary alcohol and preferably has a branched alkyl radical. Suitable alcohols are in principle all hexanols, heptanols, octanols, nonanols, decanols and mixtures thereof, with the alcohols 2-methyl-1-hexanol, 2-ethyl-1-hexanol and 3,5,5-trimethyl-1-hexanol being preferred and 2-ethyl-1-hexanol being particularly preferred. The working medium of the invention preferably comprises at least 0.0001% by weight, particularly preferably at least 0.001% by weight and in particular at least 0.0015% by weight, of the alcohol having from 6 to 10 carbon atoms. The working medium of the invention preferably comprises not more than 10% by weight, particularly preferably not more than 0.1% by weight and in particular not more than 0.05% by weight, of the alcohol having from 6 to 10 carbon atoms. Within these limits, the proportion of alcohol in the working medium is preferably selected, depending on the refrigerant used and the ionic liquid used, so that a sufficient increase in mass transfer and heat transfer in the absorber is achieved at the smallest possible amount of alcohol.

The working medium of the invention further comprises at least one ionic liquid which is composed of at least one organic cation and at least one anion and acts as sorption medium for the refrigerant when the working medium is used in an absorption heat pump. Here, the term ionic liquid refers to a salt or a mixture of salts which is composed of anions and cations and has a melting point of less than 100° C. The term ionic liquid refers to salts or mixtures of salts which are free of nonionic materials or additives. The ionic liquid preferably consists of one or more salts of organic cations with organic or inorganic anions. The ionic liquid preferably has a melting point of less than 20° C. in order to avoid solidification of the ionic liquid in the sorption medium circuit when the working medium is used in an absorption heat pump.

The anion or anions of the ionic liquid can bear one, two or more negative charges and preferably bear one negative charge and are particularly preferably anions of monovalent acids. The anion or anions of the ionic liquid preferably has/have a molecular weight of not more than 260 g/mol, particularly preferably not more than 220 g/mol, in particular not more than 180 g/mol and most preferably not more than 160 g/mol. Limiting the molar mass of the anion improves the degassing range of the working medium in the operation of an absorption heat pump.

Suitable anions are anions of monovalent inorganic acids, preferably halides, nitrate, nitrite and cyanate, and also anions of monovalent organic acids, preferably of carboxylic acids such as formate, acetate, propionate, benzoate and glycolate. Monoanions and dianions of divalent inorganic acids, preferably sulphate, hydrogensulphate, carbonate and hydrogen carbonate, and also monoanions and dianions of divalent organic acids, preferably oxalate, succinate and malonate, are likewise suitable. Monoanions, dianions and trianions of trivalent inorganic acids, preferably phosphate, hydrogenphosphate and dihydrogenphosphate, are also suitable. Further suitable inorganic anions are tetrafluoroborate, hexafluorophosphate, hydroxide, borates, haloantimonates, halocuprates, halozincates and haloaluminates. Further suitable organic anions are anions of the formulae R^{aO SO}₃⁻, R^{a}SO₃⁻, R^{a}OPO₃ ²⁻, (RₐO)₂PO₂⁻, R^{a}PO₃²⁻, R^{a}OCO₂⁻, R^{a}COO⁻, (R^{a}CO)₂N⁻, (R^{a}SO₂)₂N⁻, N(CN)₂⁻ and C(CN)₃⁻, where R^{a} is a linear or branched aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, an alkylaryl radical having from 7 to 40 carbon atoms or a linear or branched perfluoroalkyl radical having from 1 to 30 carbon atoms, and also saccharinate and anions of the formulae R^{a}OSO₃⁻ and R^{a}SO₃⁻ in which R^{a} is a polyether radical.

The anion or anions of the ionic liquid is/are preferably selected from among hydroxide, halides, nitrate, nitrite, carboxylates, phosphate, alkylphosphates, dialkylphosphates, thiocyanate, cyanate, dicyanamide, sulphate, alkylsulphates, alkylsulphonates, tetrafluoroborate and hexafluorophosphate and is/are particularly preferably selected from the group consisting of hydroxide, chloride, bromide, nitrate, nitrite, formate, acetate, propionate, glycolate, dimethylphosphate, diethylphosphate, methylsulphate and ethylsulphate.

In a preferred embodiment, the working medium comprises an ionic liquid having phosphate or phosphonate ions, in particular dimethylphosphate or diethylphosphate, in combination with methanol or ethanol as refrigerant. This combination makes it possible to simultaneously achieve a high mass transfer and heat transfer in the absorber and low corrosion and to avoid solidification of the ionic liquid in the sorption medium circuit when the working medium is used in an absorption heat pump.

The organic cation or cations of the ionic liquid can bear one, two or more positive charges and preferably bear one positive charge. The organic cation or cations of the ionic liquid preferably has/have a molecular weight of not more than 260 g/mol, particularly preferably not more than 220 g/mol, in particular not more than 195 g/mol and most preferably not more than 170 g/mol. Limiting the molar mass of the cation improves the degassing range of the working medium in the operation of an absorption heat pump.

Suitable organic cations are, in particular, cations of the general formulae (I) to (V):

R¹R²R³R⁴N⁺ (I)

R¹R²R³R⁴P⁺ (I)

R¹R²R³S⁺ (III)

R¹R²N⁺=C (NR³R⁴) (NR⁵R⁶) (IV)

R¹R²N⁺=C (NR³R⁴) (XR⁵) (V)

where

R¹,R²,R³,R⁴,R⁵,R⁶ are identical or different and are each hydrogen, a linear or branched aliphatic or olefinic hydrocarbon radical, a cycloaliphatic or cycloolefinic hydrocarbon radical, an aromatic hydrocarbon radical, an alkylaryl radical, a linear or branched aliphatic or olefinic hydrocarbon radical which is terminally functionalized by OH, OR′, NH₂, N(H)R′ or N(R′)₂ or a polyether radical of the formula —(R⁷—O)ₙ—R⁸, where R⁵ is not hydrogen in the case of cations of the formula (V),

R′ is an aliphatic or olefinic hydrocarbon radical,

R⁷ is a linear or branched alkylene radical containing 2 or 3 carbon atoms,

n is from 1 to 3,

R⁸ is hydrogen or a linear or branched aliphatic or olefinic hydrocarbon radical,

X is an oxygen atom or a sulphur atom,

where at least one and preferably each of the radicals R¹,

R², R³, R⁴, R⁵ and R⁶ is not hydrogen.

Cations of the formulae (I) to (V) in which the radicals R¹ and R³ together form a 4- to 10-membered, preferably 5- or 6-membered, ring are likewise suitable.

Heteroaromatic cations having at least one quaternary nitrogen atom bearing a radical R¹ as defined above in the ring, preferably derivatives of pyrrole, pyrazole, imidazole, oxazole, isoxazole, thiazole, isothiazole, pyridine, pyrimidine, pyrazine, indole, quinoline, isoquinoline, cinnoline, quinoxaline or phthalazine which are substituted on the nitrogen atom, are likewise suitable.

The organic cation preferably contains a quaternary nitrogen atom. The organic cation is preferably a 1-alkylimidazolium ion, 1,3-dialkylimidazolium ion, 1,3-dialkylimidazolinium ion, N-alkylpyridinium ion, N,N-dialkylpyrrolidinium ion or an ammonium ion having the structure R¹R²R³R⁴N⁺, where R¹, R² and R³ are each, independently of one another, hydrogen, alkyl or hydroxyethyl and R⁴ is an alkyl radical.

In a preferred embodiment, the organic cation is a 1,3-dialkylimidazolium ion, where the alkyl groups are selected independently from among methyl, ethyl, n-propyl and n-butyl.

In a further preferred embodiment, the organic cations are N-alkylated alkylpyridinium ions, hereinafter referred to as N-alkylalkylpyridinium ions, which can be obtained by alkylation of a mixture of alkylpyridines which are unsubstituted on the nitrogen atom, preferably N-methylalkylpyridinium ions and N-butylalkylpyridinium ions. Particular preference is given to N-alkylalkylpyridinium ions which can be obtained by alkylation of a mixture of picolines, dimethylpyridines and ethylpyridines.

Preferred organic cations are 1-methylimidazolium, 1,3-dimethylimidazolium, 1-ethyl-3-methylimidazolium, 1-butyl-3-methylimidazolium and 2-hydroxyethyltrimethyl-ammonium.

In a preferred embodiment of the working medium of the invention, the refrigerant is water and the ionic liquid is 2-hydroxyethyltrimethylammonium acetate, 2-hydroxyethyltrimethylammonium chloride, 2-hydroxyethyltrimethylammonium glycolate, 1-ethyl-3-methylimidazolium acetate, 1-ethyl-3-methylimidazolium chloride, 1-ethyl-3-methylimidazolium ethylphosphate, 1-ethyl-3-methylimidazolium methylphosphate, 1,3-diethylimidazolium diethylphosphate, 1,3-dimethylimidazolium acetate, 1,3-dimethylimidazolium propionate, N-butylalkylpyridinium chloride, N-butyl-alkylpyridinium acetate, N-methylalkylpyridinium chloride, N-methylalkylpyridinium acetate, N-butylpyridinium chloride, N-butylpyridinium acetate, N-methylpyridinium chloride, N-methylpyridinium acetate, tetramethylammonium formate, tetramethylammonium acetate, 1-butyltrimethylammonium acetate, 1-butyltrimethylammonium chloride, 1-butyltrimethylammonium formate, 1-butyl-4-methylpiperidinium acetate, N-butyl-N-methylpyrrolidinium acetate or a mixture of two or more of the ionic liquids mentioned. A particularly high degassing range and a particularly high efficiency COP are simultaneously achieved in an absorption heat pump by means of these working media.

In a further preferred embodiment of the working medium of the invention, the refrigerant is methanol or ethanol and the ionic liquid is 2-hydroxyethyltrimethylammonium acetate, 2-hydroxyethyltrimethylammonium glycolate, 1-ethyl-3-methylimidazolium acetate, 1-ethyl-3-methylimidazolium ethylphosphate, 1-ethyl-3-methylimidazolium dimethylphosphate, 1-ethyl-3-methylimidazolium diethylphosphate, 1-ethyl-3-methylimidazolium hydrogensulphate, 1-ethyl-3-methylimidazolium ethylsulphate, 1-ethyl-3-methylimidazolium methylsulphate, 1,3-dimethylimidazolium methylsulphate, 1,3-diethylimidazolium diethylphosphate, 1,3-diethylimidazolium dimethylphosphate, N-butyl-alkylpyridinium acetate, N-methylalkylpyridinium acetate, N-butylpyridinium acetate, N-methylpyridinium acetate, 1-butyltrimethylammonium acetate, 1-butyltrimethylammonium formate, 1-butyl-4-methylpiperidinium acetate, N-butyl-N-methylpyrrolidinium acetate N,N-dimethylpyrrolidinium acetate or a mixture of two or more of the ionic liquids mentioned. These working media allow cooling to temperatures below 0° C. to be carried out and a high efficiency COP to be achieved in an absorption refrigeration machine with little outlay in terms of apparatus.

The ionic liquids can be prepared by processes known from the prior art, for example as described in P. Wasserscheid, T. Welton, Ionic Liquids in Synthesis, 2nd edition, Wiley-VCH (2007), ISBN 3-527-31239-0 or in Angew. Chemie 112 (2000) pages 3926-3945.

The ionic liquid is preferably liquid at 20° C. and has a viscosity in accordance with DIN 53 019 at this temperature of from 1 to 15 000 mPa·s, particularly preferably from 2 to 10 000 mPa·s, in particular from 5 to 5000 mPa·s and most preferably from 10 to 3000 mPa·s. At a temperature of 50° C., the ionic liquid preferably has a viscosity of less than 3000 mPa·s, particularly preferably less than 2000 mPa·s and in particular less than 1000 mPa·s.

Preference is given to using ionic liquids which have unlimited miscibility with water, are stable to hydrolysis and are thermally stable up to a temperature of 100° C.

Hydrolysis-stable ionic liquids display less than 5% degradation by hydrolysis in a mixture with 50% by weight of water on storage at 80° C. for 8000 hours.

Ionic liquids which are thermally stable up to a temperature of 100° C. show a weight decrease of less than 20% in a thermogravimetric analysis under a nitrogen atmosphere on heating from 25° C. to 100° C. at a heating rate of 10° C./min. Particular preference is given to ionic liquids which display a weight decrease of less than 10% and in particular less than 5% in the analysis.

In addition to refrigerant, ionic liquid and the monohydric aliphatic alcohol having from 6 to 10 carbon atoms, the working medium of the invention can contain further additives, preferably corrosion inhibitors. The proportion of corrosion inhibitors is preferably from 10 to 50 000 ppm, particularly preferably from 100 to 10 000 ppm, based on the mass of the ionic liquid. Preferred inorganic corrosion inhibitors are Li₂CrO₄, Li₂MoO₄, Li₃VO, LiVO₃, NiBr₂, Li₃PO₄, CoBr₂ and LiOH. Suitable organic corrosion inhibitors are amines and alkanolamines, preferably 2-aminoethanol, 2-aminopropanol and 3-aminopropanol, and amides of fatty acids with alkanolamines, referred to as fatty acid alkanolamides, and alkoxylates thereof. For example, a suitable organic corrosion inhibitor is the mixture of 2-aminoethanol and oleyamidoethanol polyethoxylate which can be obtained under the trade name REWOCOROS® AC 101 from Evonik Goldschmidt GmbH. Further suitable corrosion inhibitors are organic phosphoric acid esters, in particular phosphoric acid esters of ethoxylated fatty alcohols, and fatty acid/alkanolamine mixtures. Preferred organic corrosion inhibitors are benzoimidazole and in particular benzotriazole.

In a corrosion test in accordance with ASTM D1384, the working medium of the invention preferably provides a loss of material of less than 5 g/m² for all test materials, particularly preferably less than 3 g/m² and in particular less than 2 g/m². In this test, accurately weighed metal plates of copper, soft solder, brass, steel, grey cast iron and cast aluminium provided with a hole are arranged behind one another on an insulated rod in a rack. Copper, soft solder and brass are in each case connected in an electrically conductive manner by spacers of brass, steel, grey cast iron and cast aluminium are in each case connected in an electrically conductive manner by spacers of steel, but the resulting “packets” are insulated from one another. The test specimen is submerged in the medium and heated at 88° C. for 14 days while passing air through the medium. The plates are subsequently cleaned, weighed again and the loss of material is determined.

Preference is given to working media having a combination of refrigerant and ionic liquid for which the vapour pressure of a mixture of 90% by weight of ionic liquid and 10% by weight of refrigerant at 35° C. is less than 60%, particularly preferably less than 30%, in particular less than 20% and most preferably less than 15%, of the vapour pressure of the pure refrigerant at 35° C. Such a combination of refrigerant and ionic liquid enables a wide degassing range to be achieved and the amount of working medium in the circuit of the absorption heat pump can be reduced.

The absorption heat pump of the invention comprises an absorber, a desorber, a condenser, an evaporator and a working medium according to the invention as described above.

In operation of the absorption heat pump of the invention, gaseous refrigerant is absorbed in low-refrigerant working medium in the absorber to give a refrigerant-rich working medium with liberation of heat of absorption. Refrigerant is desorbed in vapour form from the resulting refrigerant-rich working medium in the desorber with supply of heat to give low-refrigerant working medium which is recirculated to the absorber. The gaseous refrigerant obtained in the desorber is condensed in the condenser liberating heat of condensation, the liquid refrigerant obtained is vaporized in the evaporator taking up heat of vaporization and the resulting gaseous refrigerant is recirculated to the absorber.

The absorption heat pump of the invention can have either one stage or a plurality of stages with a plurality of coupled circuits of working medium.

In a preferred embodiment, the absorption heat pump is an absorption refrigeration machine and in the evaporator heat is taken up from a medium to be cooled.

The absorption heat pump of the invention has a higher efficiency compared to the absorption heat pumps known from WO 2005/113702 and WO 2006/134015 having an ionic liquid as sorption medium.

### EXAMPLES

An absorption refrigeration machine model CH-MG 150 from YAZAKI was operated using working media composed of 80% by weight of ionic liquid and 20% by weight of refrigerant at a drive temperature of 85° C. and a cooling water temperature of 30° C. and at a cooling power of about 527 kW and the efficiency COP was determined by the method described in F. Ziegler, Int. J. Therm. Sci. 38 (1999) pages 191-208. The working media were in each case tested without addition of additive and with addition of 0.01% by weight of 2-ethyl-l-hexanol (2EHL).

Table 1 shows the results for working media having water as refrigerant and Table 2 shows the results for working media having ethanol as refrigerant. In the tables, the abbreviations denote the following ionic liquids:

EMIM Cl 1-Ethyl-3-methylimidazolium chloride

EMIM OAc 1-Ethyl-3-methylimidazolium acetate

EMIM DMP 1-Ethyl-3-methylimidazolium dimethylphosphate

EMIM DEP 1-Ethyl-3-methylimidazolium diethylphosphate

Choline OAc 2-Hydroxyethyltrimethylammonium acetate

BAP Cl N-Butylalkylpyridinium chlorides

BMIM Cl 1-Butyl-3-methylimidazolium chloride

MMIM OAc 1,3-Dimethylimidazolium acetate

MMIM OPr 1,3-Dimethylimidazolium propionate

TABLE 1
Working media having water as refrigerant

| | Efficiency COP | Efficiency COP with |
|---|---|---|
| Ionic liquid | without additive | 0.01 wt.-% 2EHL |
| EMIM Cl | 0.62 | 0.70 |
| EMIM OAc | 0.69 | 0.75 |
| MMIM OAc | 0.61 | 0.73 |
| MMIM OPr | 0.64 | 0.78 |
| Choline OAc | 0.68 | 0.75 |
| BAP Cl | 0.65 | 0.72 |

TABLE 2
Working media having ethanol as refrigerant

| | Efficiency COP | Efficiency COP with |
|---|---|---|
| Ionic liquid | without additive | 0.01 wt.-% 2EHL |
| BMIM Cl | 0.41 | 0.44 |
| EMIM DMP | 0.54 | 0.58 |
| EMIM DEP | 0.57 | 0.60 |

The examples show that an improvement in the efficiency COP is found on addition of 2-ethyl-1-hexanol to the working medium both in the case of water and in the case of ethanol as refrigerant for all ionic liquids examined regardless of the anion or organic cation.

1-14. (canceled)

15. A working medium for absorption heat pumps, comprising at least one refrigerant, at least one monohydric aliphatic alcohol having from 6 to 10 carbon atoms and at least one ionic liquid composed of at least one organic cation and at least one anion.

16. The working medium of claim 15, comprising from 4 to 67% by weight of refrigerant, from 0.0001 to 10% by weight of alcohol having from 6 to 10 carbon atoms and from 30 to 95% by weight of ionic liquid.

17. The working medium of claim 15, wherein the alcohol is a primary alcohol.

18. The working medium of claim 15, wherein the alcohol has a branched alkyl radical.

19. The working medium of claim 15, wherein the alcohol is 2-ethyl-1-hexanol.

20. The working medium of claim 15, wherein the refrigerant is selected from the group consisting of water, methanol, ethanol and mixtures thereof

21. The working medium of claim 20, wherein the refrigerant is selected from the group consisting of methanol, ethanol, mixtures of methanol with ethanol, mixtures of ethanol with water and mixtures of methanol with water.

22. The working medium of claim 15, wherein the anion or anions of the ionic liquid has/have a molecular weight of not more than 260 g/mol.

23. The working medium of claim 15, wherein the anion or anions of the ionic liquid is/are selected from the group consisting of: hydroxide, halides, nitrate, nitrite, carboxylates, phosphate, alkylphosphates, dialkylphosphates, thiocyanate, cyanate, dicyanamide, sulphate, alkylsulphates, alkylsulphonates, tetrafluoroborate and hexafluorophosphate.

24. The working medium of claim 23, wherein the anion or anions of the ionic liquid is/are selected from the group consisting of: hydroxide, chloride, bromide, nitrate, nitrite, formate, acetate, propionate, glycolate, dimethylphosphate, diethylphosphate, methylsulphate and ethylsulphate.

25. The working medium of claim 15, wherein the organic cation or cations of the ionic liquid has/have a molecular weight of not more than 260 g/mol.

26. The working medium of claim 15, wherein the organic cation or cations of the ionic liquid is/are selected from the group consisting of 1-alkylimidazolium ions, 1,3-dialkylimidazolium ions, 1,3-dialkylimidazolinium ions, N-alkylpyridinium ions, N,N-dialkylpyrrolidinium ions and ammonium ions having the structure R¹R²R³R⁴N⁺, where R¹, R² and R³ are each, independently of one another, hydrogen, alkyl or hydroxyethyl and R⁴ is an alkyl radical.

27. The working medium of claim 26, wherein the organic cation or cations of the ionic liquid is/are selected from the group consisting of: 1-methylimidazolium, 1,3-dimethylimidazolium, 1-ethyl-3-methylimidazolium, 1-butyl-3-methylimidazolium and 2-hydroxyethyltrimethylammonium.

28. The working medium of claim 15, wherein the refrigerant is water and an ionic liquid is selected from the group consisting of:
2-hydroxyethyltrimethylammonium acetate,
2-hydroxyethyltrimethylammonium chloride,
2-hydroxyethyltrimethylammonium glycolate,
1-ethyl-3-methylimidazolium acetate,
1-ethyl-3-methylimidazolium chloride,
1-ethyl-3-methylimidazolium ethylphosphate,
1-ethyl-3-methylimidazolium methylphosphate,
1,3-diethylimidazolium diethylphosphate,
1,3-dimethylimidazolium acetate,
1,3-dimethylimidazolium propionate,
N-butylalkylpyridinium chlorides,
N-butyl-alkylpyridinium acetates,
N-methylalkylpyridinium chlorides,
N-methyl-alkylpyridinium acetates,
N-butylpyridinium chloride,
N-butylpyridinium acetate,
N-methylpyridinium chloride,
N-methylpyridinium acetate,
tetramethylammonium formate,
tetramethylammonium acetate,
1-butyltrimethylammonium acetate,
1-butyltrimethylammonium chloride,
1-butyltrimethylammonium formate,
1-butyl-4-methylpiperidinium acetate,
N-butyl-N-methylpyrrolidinium acetate, and mixtures thereof.

29. The working medium of claim 15, wherein the refrigerant is methanol or ethanol and an ionic liquid is selected from the group consisting of:
2-hydroxyethyltrimethylammonium acetate,
2-hydroxyethyltrimethylammonium glycolate,
1-ethyl-3-methylimidazolium acetate,
1-ethyl-3-methylimidazolium ethylphosphate,
1-ethyl-3-methylimidazolium dimethylphosphate,
1-ethyl-3-methylimidazolium diethylphosphate,
1-ethyl-3-methylimidazolium hydrogensulphate,
1-ethyl-3-methylimidazolium ethylsulphate,
1-ethyl-3-methylimidazolium methylsulphate,
1,3-dimethylimidazolium methylsulphate,
1,3-diethylimidazolium diethylphosphate,
1,3-diethylimidazolium dimethylphosphate,
N-butylalkylpyridinium acetates,
N-methyl-alkylpyridinium acetates,
N-butylpyridinium acetate,
N-methylpyridinium acetate,
1-butyltrimethylammonium acetate,
1-butyltrimethylammonium formate,
1-butyl-4-methylpiperidinium acetate,
N-butyl-N-methylpyrrolidinium acetate,
N,N-dimethylpyrrolidinium acetate, and mixtures thereof.

30. An absorption heat pump comprising an absorber, a desorber, a condenser, an evaporator and a working medium according to claim 1.

31. The absorption heat pump of claim 30, wherein said absorption heat pump is an absorption refrigeration machine taking up heat in the evaporator from a medium to be cooled.
